(19) United States
(12) Patent Application Publication
(10) Pub. No.: US 2003/0104237 A1
(43) Pub. Date: Jun. 5, 2003

(54) Paper for newspaper

(76) Inventors: Shinichi Nakayama, Ouji 5-chome Kita-ku (JP); Kazufumi Yamazaki, Kita-ku (JP); Yozo Igarashi, Kita-ku (JP); Hideki Fujiwara, Kita-ku (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/181,217

(22) PCT Filed: Jan. 12, 2001
(86) PCT No.: PCT/JP01/00102

(30) Foreign Application Priority Data
Jan. 12, 2000 (JP) 2000-3875

(51) Int. Cl. B32B 23/04

(52) U.S. Cl. 428/537.5; 428/532

(57) ABSTRACT

Paper for newspaper, having a basis weight of 35 to 45 g/m², and whose average pure flexural stiffness in the widthwise direction is adjusted to a range of 1 to 11 μN·m²/m following humidity conditioning at 23° C., 50% RH, and whose pH value is 5 to 9.5 as measured per the cold extraction-based pH test method of paper as defined in JIS P8133, and which doesn't cause forming jamming and offers excellent printability.

### FIELD OF THE INVENTION

This invention relates to paper for newspaper that could offer excellent bending property in the folding section of a web-offset rotary press.

### BACKGROUND OF THE INVENTION

Newspaper publishers have been diversifying printing locations over the past several years for the purpose of featuring the latest news articles. With the introduction of digital technology, the time required for the entire printing process, from the sending and receipt of manuscripts and plate making to final printing, has been dramatically reduced. As newspaper companies implement thoroughgoing efforts to improve the efficiency of printing, the question of how to shorten printing time presents a great challenge, and to that end a number of technologies have been developed. At the same time, the industry demands printing paper that is problem-free and offers good printability, thus contributing to a shorter printing time.

Generally speaking, many problems can occur in the process of printing newspapers. Among them, problems that affect work efficiency and ultimately cause delays in printing are the ones most dreaded at the print site. For example, forming jamming is one of the problems affecting printing efficiency.

Forming jamming is explained with reference to FIG. 1. The papers printed in different presses are stacked together at the entrance to the folding section. The paper stack is then pulled by a drag roller 5 and feeder pin 4, and is cut to the width of two facing pages by a slitter knife 12 at the center. The newly sized papers are fed over a former (triangular plate) 6 and through forming rollers 7, finally reach nipping rollers 8, where the papers are folded lengthwise. The folded papers are cut to the length of one page by a shearing cylinder 2 as they pass between the shearing cylinder 2 and a folding cylinder 3, and then folded widthwise along the center by the folding cylinder 3 and folding rollers 9. Subsequently, the papers thus folded in four are fed into a delivery fan 10, through which they are discharged onto a delivery belt 11 and output from the folding section. The machine also has transfer rollers 13, which are used to transfer the papers to the folding mechanism on the opposite side when the current folding mechanism does not work properly.

In this process, papers sometimes jam near the former. This phenomenon is referred to as “forming jamming.” Also, if a section of paper torn at the tip of the former is rolled up and passes through the nipping rollers as a large chunk, the rolls or folding machine may be damaged, causing a serious problem.

### SUMMARY OF THE INVENTION

Although forming jamming can lead to serious problems as explained above, the cause of jamming has in academic literature rarely been discussed from the viewpoint of paper quality.

The inventors of this invention took notice of the potential causes of forming jamming, such as the rigidity of paper, which makes it difficult to fold stacked papers, and poor running performance of paper on the former. To analyze the factors of forming jamming, the various physical properties of papers that did and did not cause forming jamming were compared.

First, the friction coefficient, which serves as an index of the running stability of paper, was measured. The result made it clear that the level of friction coefficient has nothing to do with the occurrence of forming jamming. Next, the rigidity (stiffness) of paper was examined. The Clark stiffness value—a measure generally used in the evaluation of paper rigidity—was compared between a paper that caused forming jamming and one that didn't. No clear correlation was found in this comparison. However, when the rigidity of each paper was evaluated by hand, the paper that didn't cause forming jamming was clearly felt softer and less rigid compared with the paper that caused forming jamming. Still, the sensory evaluation results didn't fully correspond to the Clark stiffness values.

To reduce the rigidity of paper and make it softer, the inventors examined various ways such as applying more calendering, increasing the mixing ratio of wastepaper pulp, and raising the ash content in paper. However, these methods didn't always improve the situation with regard to forming jamming. In some cases other problems were caused by the increased wrinkling of paper, poor running performance, and the increased generation of linting. As a result, they failed to provide effective countermeasures.

The use of a surface-active agent referred to as “softener” is being examined as a means of reducing the rigidity of paper and making it softer. However, the use of softener noticeably reduces the strength of the paper, giving rise to the problem of breaking. Therefore, the application of softener to paper for newspaper is not ideal.

Given such conditions, this invention was developed with the aim of providing paper for newspaper that could offer excellent folding property and minimize the forming jamming often seen in web-offset rotary presses.

After eagerly examining possible solutions to the above problem, the inventors found a correlation between the folding property and the average pure flexural stiffness of paper. The inventors also found that if the average pure flexural stiffness of paper in the direction perpendicular to the direction of printing, i.e., the widthwise direction, is within the range of 1 to 11 μN·m² /m, as measured following humidity conditioning at 23° C., 50% RH, then in the practical sense forming jamming doesn't occur. These findings led to the achievement of this invention.

In Japanese Patent Application No. 2000-3875, the inventors specified that paper must have 1 to 10 μN·m²/m of average pure flexural stiffness in the widthwise direction, as measured following humidity conditioning at 20° C., 65% RH, in order to prevent forming jamming. However, with the change of the humidity-conditioning standard for paper from the JIS method (20° C., 65% RH) to the ISO method (23° C., 50% RH), in this patent application we also changed our humidity-conditioning requirement to 23° C., 50% RH.

### BRIEF DESCRIPTION OF THE DRAWINGS

FIG. 1 is a general view of the folding section of a web-offset rotary press used for printing newspapers.

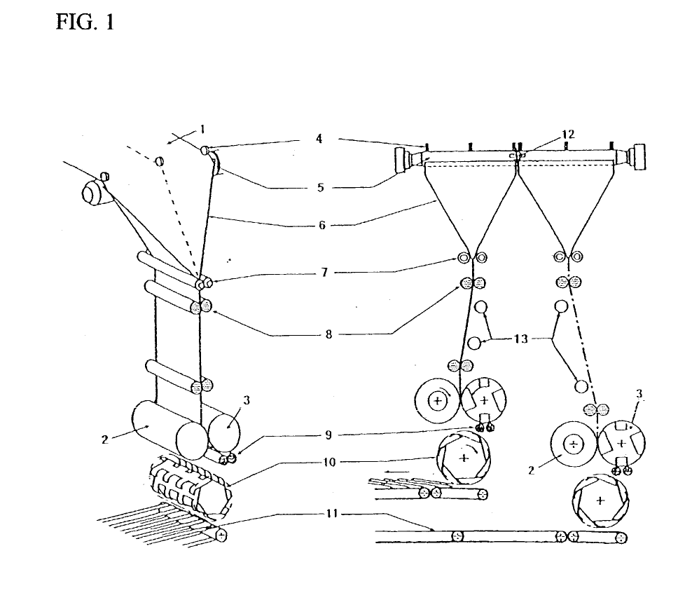

### DESCRIPTIONS OF THE SYMBOLS

1: Uncut paper

2: Shearing cylinder

3: Folding cylinder

4: Feeder pin

5: Drag roller

6: Former (triangular plate)

7: Forming roller

8: Nipping roller

9: Folding roller

10: Delivery fan

11: Delivery belt

12: Slitter knife

13: Transfer roller

### BEST MODE FOR CARRYING OUT THE INVENTION

This invention is based on a correlation between pure flexural stiffness in the paper's widthwise direction on one hand and the result of sensory evaluation on the other, as found through an investigation of paper's physical properties as corresponding to the results of sensory evaluation. The widthwise direction refers to the direction perpendicular to the printing direction of the newspaper rolls as they run through a web-offset rotary press.

Although it is not entirely clear why the results of sensory evaluation varied between Clark stiffness—a measure generally used in the evaluation of paper rigidity—and pure flexural stiffness, a possible explanation is that the Clark stiffness value is measured in the elastic range, whereas pure flexural stiffness is measured under conditions in which the sample is bent 90 degrees or more, indicating a range in excess of the elastic range.

Furthermore, while Clark stiffness is affected by the dead weight of the sample, average pure flexural stiffness is not subject to such effect, which may have contributed to the difference in the sensory evaluation result with regard to rigidity.

This invention is characterized by a paper for newspaper that could offer excellent folding property while suppressing forming jamming, by fixing the average pure flexural stiffness in the paper's widthwise direction to a range of 1 to 11 μN·m²/m, as measured following humidity conditioning at 23°0 C., 50% RH.

The former or nipping roller of a web-offset rotary press used for printing newspapers can fold papers at an angle in excess of 90 degrees, and on a practical basis up to 180 degrees. Therefore, the folding property of paper is deemed to have a good correlation with pure flexural stiffness. If the average pure flexural stiffness is below 1 μN·m²/m, the rigidity becomes too low and the paper won't run properly in the web-offset rotary press. On the other hand, the average pure flexural stiffness exceeding 11 μN·m²/m makes folding difficult, thus increasing the occurrences of forming jamming.

The various means for fixing the average pure flexural stiffness in the paper's widthwise direction to a range of 1 to 11 μN·m²/m include applying more calendering, increasing the mixing ratio of deinked pulp, increasing the mixing ratio of filler, intensifying the beating of the pulp, and adding softener and other additives. However, these methods change other physical properties of the paper, including its strength, density and printability. This is why it has been difficult to fix the average pure flexural stiffness to a range of 1 to 11 μN·m²/m without affecting the quality of the paper.

Alternatively, the inventors found a means for fixing the average pure flexural stiffness to a range of 1 to 11 μN·m²/m without affecting the quality of paper too much, by fixing the pH value of paper between 5 and 9.5—or more preferably, between 6.5 and 9.5—using the cold extraction-based pH test method of paper as defined in JIS P8133.

The paper for newspaper provided by this invention is made by mixing kraft pulp, ground wood pulp, thermo-mechanical pulp, chemi-thermo-mechanical pulp and deinked pulp at arbitrary ratios and forming the mixed materials into sheets having a basis weight of 35 to 45 g/m² or less. As for deinked pulp, an increased mixing ratio helps lower the average pure flexural stiffness. The ratio of deinked pulp to total pulp components should preferably be 50 wt-% or more. Softener may be added to adjust the average pure flexural stiffness to a range of between 1 and 11 μN·m²/m.

The paper for newspaper provided by this invention is manufactured using a publicly known paper machine, such as a Fourdrinier paper machine or a twin-wire paper machine of on-top, hybrid or gapped former type. The jet-wire ratio should be set as appropriate in the range of 90 to 110 percent. A setting between 97 and 103 percent is normally preferred.

The paper for newspaper provided by this invention may contain fillers such as calcium carbonate, clay, kaoline, white carbon, titanium oxide and synthetic resin (vinyl-chloride resin, polystyrene resin or urea-formalin resin). As a means for fixing the paper's pH value to a range of 6.5 to 9.5 using the aforementioned cold extraction-based pH test method of paper as defined in JIS P8133, the use of calcium carbonate as a filler is recommended. The mixing ratio of filler should preferably be between 2 and 12 wt-% in ash content, or more preferably, between 4 and 10 wt-%. Normally, the addition of a filler reduces the average pure flexural stiffness. However, if the filler is less than 2 wt-% in ash content, its impact on the average pure flexural stiffness will be minimal. On the contrary, if the ash content of the added filler exceeds 12 wt-%, more powder particles will be generated during printing.

The paper for newspaper provided by this invention may be coated with surface-treatment agents such as starch, including oxidized starch, esterified starch, eterized starch and cationized starch, polyacrylamide and polyvinyl alcohol, within a range not affecting the average pure flexural stiffness.

Additionally, it is possible to apply surface-sizing agents such as styrene/acrylate copolymer, styrene/(meth)acrylate copolymer (the term “(meth)acrylate” herein referring to “acrylate and/or methacrylate”), styrene/(meth)acrylate/(meth)acrylate ester copolymer, styrene/maleate copolymer, styrene/maleate half-ester copolymer, styrene/maleate ester copolymer, ethylene/acrylate copolymer, isobutylene/acrylate copolymer, n-butylene/(meth)acrylate/(meth)acrylate ester copolymer, propylene/maleate copolymer and ethylene/maleate copolymer.

Furthermore, if necessary the paper for newspaper provided by this invention may contain: sizing agents such as rosin sizing agent, rosin-emulsion sizing agent, alkylketene dimer and alkenyl succinic anhydride; paper-reinforcing agents such as polyacrylamide high polymer, polyvinyl-alcohol high polymer, cationized starch, urea/formalin resin and melamine/formalin resin; freeness-enhancing or retention-aiding agents such, as acrylamide/aminomethyl acrylamide copolymer salt, cationized starch, polyethyleneimine, polyethylene oxide and acrylamide/sodium acrylate copolymer; or auxiliaries such as aluminum sulfate, waterproofing agent, UV-protection agent and fadeproofing agent.

The physical properties of the paper for newspaper provided by this invention must accommodate printing by a web-offset rotary press. It should be sufficient if the tensile strength, tear strength, elongation and other physical properties of the paper are equivalent to those of normal papers used for newspaper printing.

### [EXAMPLES]

The following is a detailed explanation of this invention using examples. However, the invention is not limited to the examples provided.

The measurement/test methods and evaluation methods used in the examples are specified below:

(1) Average pure flexural stiffness: A test piece of 100 mm in length and 100 mm in width was cut from a sample subjected to humidity conditioning at 23° C., 50% RH. A bending force was applied in the widthwise direction of the test piece using a pure flexural stiffness tester (JTC-1, by Nihon Seiki Seisakusho) at a deformation speed of 0.5 cm⁻¹/sec. Curvature and torque were then measured, and the slope of the obtained bending moment-curvature curve was used in order to calculate the average pure flexural stiffness. Average pure flexural stiffness was also measured for a test piece subjected to humidity conditioning at 20° C., 65% RH.

(2) Clark stiffness: Measured in the paper's widthwise direction, in accordance with JIS P8143: 1967, following humidity conditioning at 23° C., 50% RH.

(3) Friction coefficient: JIS P8147: 1994 was followed.

(4) pH: JIS P8133: 1998 was followed.

(5) Ash content: Measured at 575° C., in conformance with ISO 2144-1987 (JIS P8128).

(6) Evaluation of forming jamming: The samples were printed by a web-offset rotary press by Mitsubishi Heavy Industries at a printing speed of 120,000 copies per hour, and the folding section was observed for occurrences of forming jamming.

### [Example 1]

Paper for newspaper having a basis weight of 45 g/m² was produced by mixing six parts of softwood kraft pulp, 10 parts of ground pulp, 16 parts of thermo-mechanical pulp and 68 parts of deinked wastepaper pulp, adding as a filler a mixture of calcium carbonate and white carbon to six percent in ash content, and then forming the mixed materials into sheet of paper using a twin-wire-type paper machine at a jet-wire ratio of 103 percent.

Average pure flexural stiffness, Clark stiffness, friction coefficient, pH and ash content were measured for the obtained paper roll, and evaluation of forming jamming was also conducted. The results are shown in Table 1.

### [Example 2]

Paper for newspaper having a basis weight of 45 g/m² was produced by mixing five parts of soft wood kraft pulp, 12 parts of ground pulp, 13 parts of thermo-mechanical pulp and 70 parts of deinked wastepaper pulp, adding as a filler a mixture of calcium carbonate and white carbon to six percent in ash content, and forming the mixed materials into sheet of paper using a twin-wire-type paper machine at a jet-wire ratio of 100%.

Average pure flexural stiffness, Clark stiffness, friction coefficient, pH and ash content were measured for the obtained paper roll, and evaluation of forming jamming was also conducted. The results are shown in Table 1.

### [Example 3]

Paper for newspaper having a basis weight of 44 g/m² was produced by mixing five parts of soft wood kraft pulp, 12 parts of ground pulp, 13 parts of thermo-mechanical pulp and 70 parts of deinked wastepaper pulp, adding as a filler a mixture of calcium carbonate and white carbon to six percent in ash content, and forming the mixed materials into sheet of paper using a twin-wire-type paper machine at a jet-wire ratio of 100%.

Average pure flexural stiffness, Clark stiffness, friction coefficient, pH and ash content were measured for the obtained paper roll, and evaluation of forming jamming was also conducted. The results are shown in Table 1.

### [Comparative Example 1]

Paper for newspaper having a basis weight of 46 g/m² was produced by mixing 10 parts of softwood kraft pulp, 13 parts of ground pulp, 17 parts of thermo-mechanical pulp and 60 parts of deinked wastepaper pulp, adding kaoline to six percent in ash content as a filler, and forming the mixed materials into sheet of paper using a twin-wire-type paper machine at a jet-wire ratio of 101 percent.

Average pure flexural stiffness, Clark stiffness, friction coefficient, pH and ash content were measured for the obtained paper roll, and evaluation of forming jamming was also conducted. The results are shown in Table 1.

### [Comparative Example 2]

Paper for newspaper having a basis weight of 46 g/m² was produced by mixing 10 parts of soft wood kraft pulp, 13 parts of ground pulp, 17 parts of thermo-mechanical pulp and 60 parts of deinked wastepaper pulp, adding kaoline to six percent in ash content as a filler, and forming the mixed materials into sheet of paper using a twin-wire-type paper machine at a jet-wire ratio of 100%.

Average pure flexural stiffness, Clark stiffness, friction coefficient, pH and ash content were measured for the obtained paper roll, and evaluation of forming jamming was also conducted. The results are shown in Table 1.

### [Comparative Example 3]

Paper for newspaper having a basis weight of 45 g/m² was produced by mixing 10 parts of soft wood kraft pulp, 13 parts of ground pulp, 17 parts of thermo-mechanical pulp and 60 parts of deinked wastepaper pulp, adding kaoline to six percent in ash content as a filler, and forming the mixed materials into sheet of paper using a twin-wire-type paper machine at a jet-wire ratio of 100%.

Average pure flexural stiffness, Clark stiffness, friction coefficient, pH and ash content were measured for the obtained paper roll, and evaluation of forming jamming was also conducted. The results are shown in Table 1.

### [Comparative Example 4]

Paper for newspaper having a basis weight of 44 g/m² was produced by mixing six parts of soft wood kraft pulp, 10 parts of ground pulp, 16 parts of thermo-mechanical pulp and 68 parts of deinked wastepaper pulp, adding kaoline to six percent in ash content as a filler, and forming the mixed materials into sheet of paper using a twin-wire-type paper machine at a jet-wire ratio of 100%.

Average pure flexural stiffness, Clark stiffness, friction coefficient, pH and ash content were measured for the obtained paper roll, and evaluation of forming jamming was also conducted. The results are shown in Table 1.

TABLE 1

| | Average pure | Average pure | | | | | | |
|---|---|---|---|---|---|---|---|---|
| | flexural | flexural | | | | | | |
| | stiffness | stiffness | | Friction | | | Ash | |
| | (μN · m²/m) | (μN · m²/m) | Clark stiffness | coefficient | | | content | Forming |
| | (23° C., 50% RH) | (20° C., 65% RH) | (cm³/100) | Static | Dynamic | pH | (%) | jamming |
| Example 1 | 10.8 | 9.8 | 12 | 0.59 | 0.58 | 9.0 | 6.2 | Didn't |
| | | | | | | | | occur |
| Example 2 | 9.8 | 7.8 | 9 | 0.58 | 0.55 | 8.9 | 6.3 | Didn't |
| | | | | | | | | occur |
| Example 3 | 8.2 | 7.8 | 10 | 0.63 | 0.58 | 9.0 | 8.2 | Didn't |
| | | | | | | | | occur |
| Comparative | 11.6 | 10.8 | 10 | 0.55 | 0.55 | 5.3 | 4.3 | Occurred |
| example 1 | | | | | | | | |
| Comparative | 11.5 | 10.8 | 11 | 0.53 | 0.54 | 4.9 | 5.9 | Occurred |
| example 2 | | | | | | | | |
| Comparative | 11.8 | 12.7 | 10 | 0.44 | 0.45 | 4.8 | 5.8 | Occurred |
| example 3 | | | | | | | | |
| Comparative | 11.5 | 11.0 | 11 | 0.58 | 0.55 | 4.8 | 5.8 | Occurred |
| example 4 | | | | | | | | |

### [Evaluation of Results]

As shown in Table 1, the papers for newspaper provided in examples 1 to 3, whose average pure flexural stiffness in the widthwise direction was fixed to a range of 1 to 11 μN·m²/m following humidity conditioning at 23° C., 50% RH, offer excellent folding property and running performance and didn't cause forming jamming when printed in an actual web-offset rotary press at a printing speed of 120,000 copies per hour or more.

It was also confirmed that occurrence of forming jamming has no correlation with the values of friction coefficient or of Clark stiffness, a measure generally used in the evaluation of paper rigidity.

Industrial Field of Application

Conventionally, methods such as applying more calendering, increasing the mixing ratio of wastepaper pulp, and raising the ash content in paper were examined as ways of reducing the rigidity of paper and making it softer. However, these methods didn't improve the situation of forming jamming but gave rise to other problems through the increased wrinkling of paper, poor running performance and the generation of powder particles. Adding softener, a surface-active agent, for the purpose of reducing the paper's rigidity and making it softer has been difficult to apply to paper for newspaper, since it produces a noticeable drop in the paper's strength, thereby posing a risk of breaking.

This invention, however, made it possible to provide paper for newspaper that could offer excellent folding property and reduce the occurrence of forming jamming often seen in web-offset rotary presses, based on the findings that the folding property of paper correlates to the average pure flexural stiffness and that forming jamming doesn't practically occur if the average pure flexural stiffness of paper in the direction perpendicular to the direction of printing, i.e., the widthwise direction, is within the range of 1 to 11 μN·m²/m, as measured following humidity conditioning at 23° C., 50% RH.

What is claimed is:

1. A paper for newspaper which has a basis weight of 35 to 45 g/m², wherein its average pure flexural stiffness in the widthwise direction is 1 to 11 μN·m²/m, as measured following humidity conditioning at 23° C., 50% RH.

2. The paper for newspaper according to claim 1, wherein a pH value is 5 to 9.5, as measured per the cold extraction-based pH test method of paper as defined in JIS P8133.

3. The paper for newspaper according to claim 1 or 2, wherein a content of wastepaper pulp to the total pulp component is 50 wt-% or more.

4. The paper for newspaper according to any one of claims 1 to 3, wherein an ash content is 4 to 10 wt-%.
